(19) United States
(12) Patent Application Publication
(10) Pub. No.: US 2018/0038274 A1
(43) Pub. Date: Feb. 8, 2018

(54) ACCESSORY MOUNTING STRUCTURE FOR ENGINE

(71) Applicant: MAZDA MOTOR CORPORATION, Hiroshima (JP)

(72) Inventors: Hidesaku EBESU, Hiroshima-shi (JP); Ryotaro NISHIDA, Hiroshima-shi (JP)

(73) Assignee: MAZDA MOTOR CORPORATION, Hiroshima (JP)

(21) Appl. No.: 15/551,646

(22) PCT Filed: Apr. 21, 2016
(86) PCT No.: PCT/JP2016/062629

§ 371 Date: Aug. 17, 2017

(30) Foreign Application Priority Data
Apr. 23, 2015 (JP) 2015-088270
Apr. 23, 2015 (JP) 2015-088271

(51) Int. Cl. F02B 67/06; F02M 55/02; F02F 7/00

(52) U.S. Cl. CPC F02B 67/06; F02F 7/0007; F02M 55/02; F02M 37/043

(57) ABSTRACT

An accessory mounting structure for an engine includes an engine body, and a transmission disposed on an end of the engine body in the cylinder array direction and to which output of the engine is transmitted via a crankshaft of the engine body. When the output side of the crankshaft with respect to the transmission in the cylinder array direction is defined as a rear side, and the side of the crankshaft opposite to the rear side is defined as a front side, a fuel pump configured to feed fuel to an injector, and a starter configured to rotate the crankshaft at an engine start time are disposed on a rear end portion of an intake manifold mounting surface of the engine body. When the engine is viewed from the cylinder array direction, the starter projects outwardly with respect to the fuel pump in the engine width direction.

### TECHNICAL FIELD

The present invention relates to an accessory mounting structure for an engine in an automobile or a like vehicle. More specifically, the present invention relates to an accessory mounting structure for an engine provided with a fuel pump configured to feed fuel to an injector.

### BACKGROUND ART

In an automobile or a like vehicle, there is a transversely mounted engine, which is mounted in an engine room of a vehicle front portion in such a manner that the cylinder array direction is aligned with the vehicle width direction. The engine is mounted in an engine room in such a manner that a surface of an engine body on the intake side including a cylinder block faces the vehicle front side, and a surface of the engine body on the exhaust side faces the vehicle rear side. According to this configuration, it is possible to avoid lowering of an exhaust temperature due to traveling air, and to activate an exhaust purification device in an early stage and to maintain activation of the exhaust purification device.

In this case, in an engine configured to directly inject fuel to a combustion chamber such as a diesel engine or a direct injection engine (a cylinder injection engine), a high fuel pressure is required. This may increase the drive load of a fuel pump configured to feed fuel to an injector. In order to chain-drive a fuel pump by a crankshaft while avoiding a high temperature condition, the fuel pump is disposed on a side surface of an engine body on the intake side, in other words, on a side surface of an engine body on the vehicle front side. This may require a measure for protecting a fuel pump from a collision object from the vehicle front side at vehicle collusion (from the front side).

Regarding this point, Patent Literature 1 discloses disposing a fuel pump on a side surface of an end portion of an engine on the vehicle front side, and disposing a cover plate for protecting a vehicle from collision in such a manner that the cover plate covers a surface of the fuel pump on the vehicle front side. According to this configuration, it is possible to protect the fuel pump by the cover plate at vehicle collision from the front side.

As described above, in a transversely mounted engine configured such that a fuel pump is disposed on a side surface of an engine body on the vehicle front side and on an end portion of the engine body on the rear side (on the output side of a crankshaft with respect to a transmission in the cylinder array direction), it is necessary to provide a measure for protecting the fuel pump at vehicle collision from the front side.

In this case, if a dedicated protection member is additionally provided as disclosed in Patent Literature 1, not only the space for an engine room may be narrowed, but also the weight and the cost of an engine may increase.

### CITATION LIST

### Patent Literature

Patent Literature 1: Japanese Unexamined Patent Publication No. 2007-16716

### SUMMARY OF INVENTION

The present invention relates to an accessory mounting structure for an engine provided with a fuel pump configured to feed fuel to an injector. An object of the present invention is to provide an accessory mounting structure for an engine, which enables to protect a fuel pump from a collision object at vehicle collision.

The present invention is directed to an accessory mounting structure for an engine including an engine body in which a plurality of cylinders are arranged in a row, and a transmission disposed on an end of the engine body in the cylinder array direction and to which output of the engine is transmitted via a crankshaft of the engine body. When an output side of the crankshaft with respect to the transmission in the cylinder array direction is defined as a rear side, and a side of the crankshaft opposite to the output side is defined as a front side, a fuel pump configured to feed fuel to an injector, and a starter configured to rotate the crankshaft at an engine start time are disposed on a rear end portion of an intake manifold mounting surface of the engine body. The starter projects outwardly with respect to the fuel pump in an engine width direction orthogonal to the cylinder array direction when the engine is viewed from the cylinder array direction.

### BRIEF DESCRIPTION OF DRAWINGS

FIG. 1 is a schematic plan view of an engine according to an embodiment of the present invention;

FIG. 2 is a left side view of the engine in a state that a chain cover and a transmission are removed;

FIG. 3 is a front view of a body of the engine;

FIG. 4 is a left side view of the engine in a state that the chain cover and the transmission are removed;

FIG. 5 is a schematic front view of a rear end portion of the engine body;

FIG. 6 is a left side view of a cylinder block of the engine;

FIG. 7 is a schematic and partially longitudinal sectional view of the rear end portion of the engine body;

FIG. 8 is a perspective view of the engine when viewed from the front right side of the cylinder block;

FIG. 9 is an expanded view of the rear end portion of the engine body;

FIG. 10 is a left side view of a lower portion of the rear end portion of the engine body (in a state that an oil pan is removed); and

FIG. 11 is a perspective view of the engine when viewed from the front left side.

### DESCRIPTION OF EMBODIMENTS

In the following, an embodiment of the present invention is described based on the drawings.

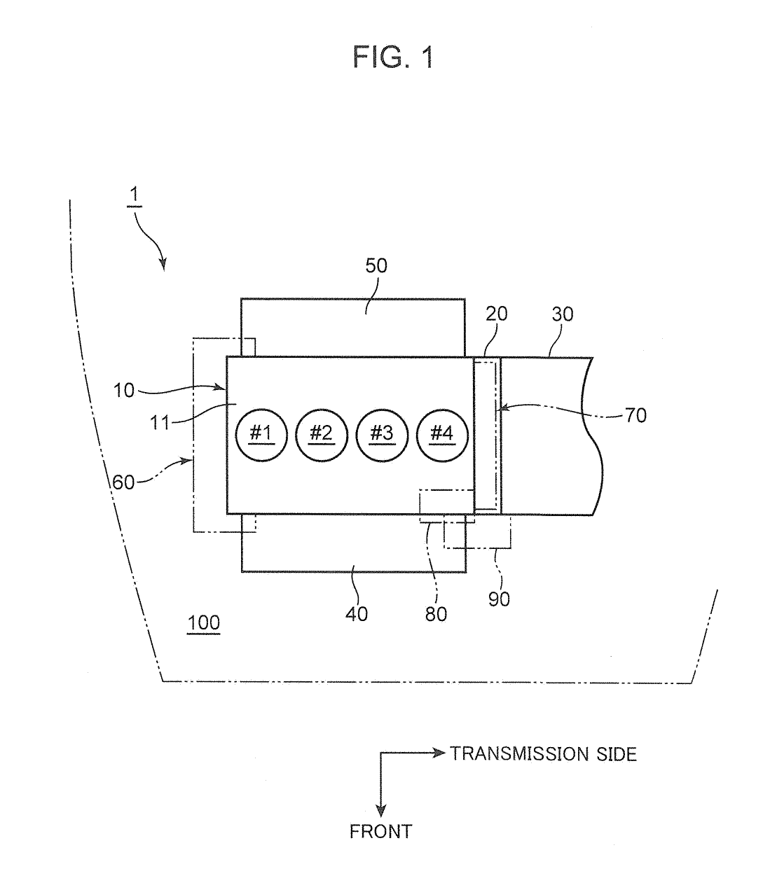

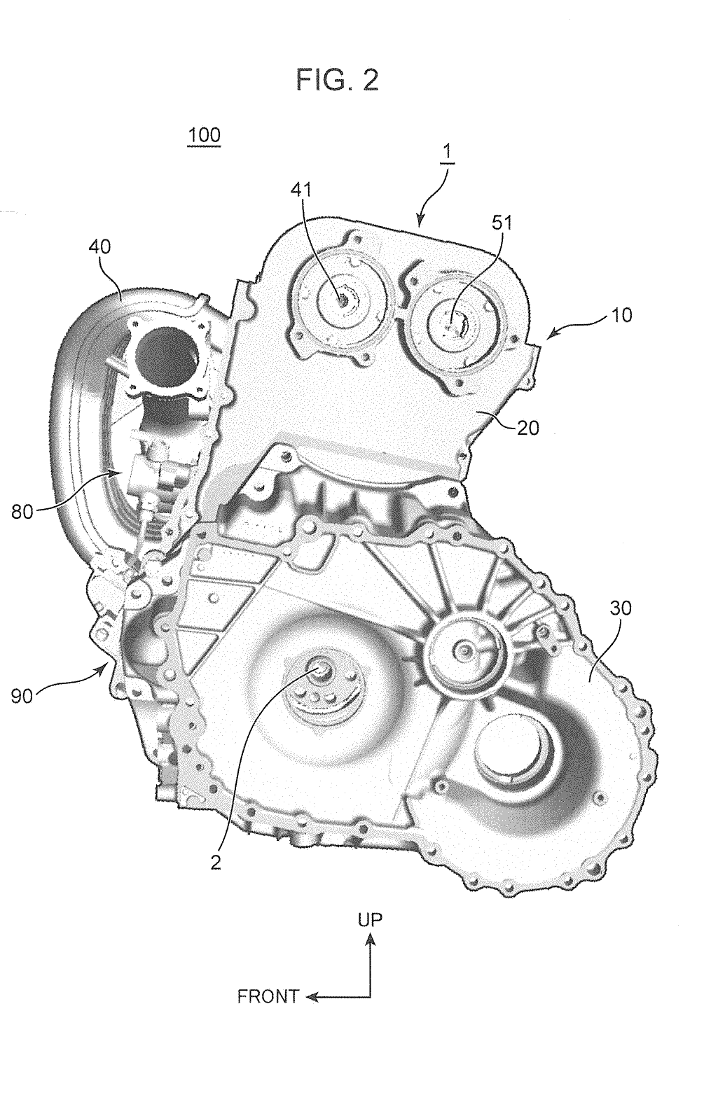

As illustrated in FIG. 1 and FIG. 2, an engine 1 according to the embodiment is an in-line 4-cylinder diesel engine (provided with a first cylinder #1, a second cylinder #2, a third cylinder #3, and a fourth cylinder #4), which is transversely mounted in an engine room 100 of a vehicle front portion in such a manner that the cylinder array direction is aligned with the vehicle width direction (an FF-vehicle). Although not illustrated, the engine 1 has a well-known structure, in which pistons, injectors (fuel injection valves), intake ports, exhaust ports, intake valves, and exhaust valves are provided on the outside or the inside of the cylinders.

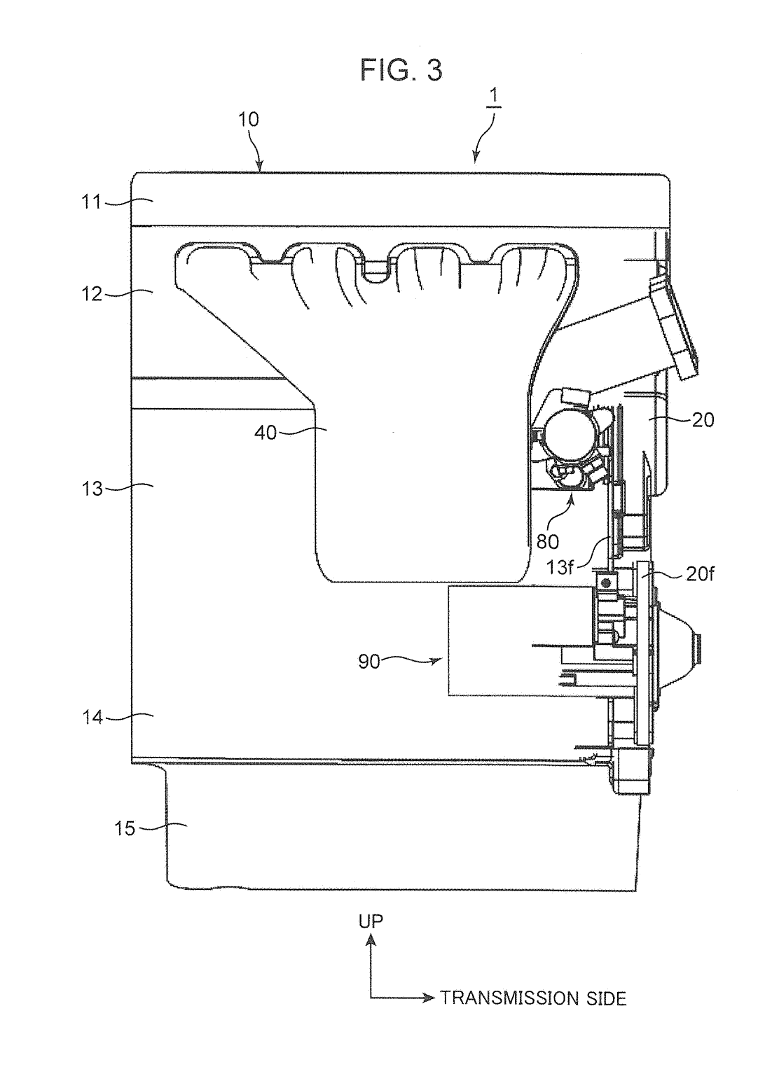

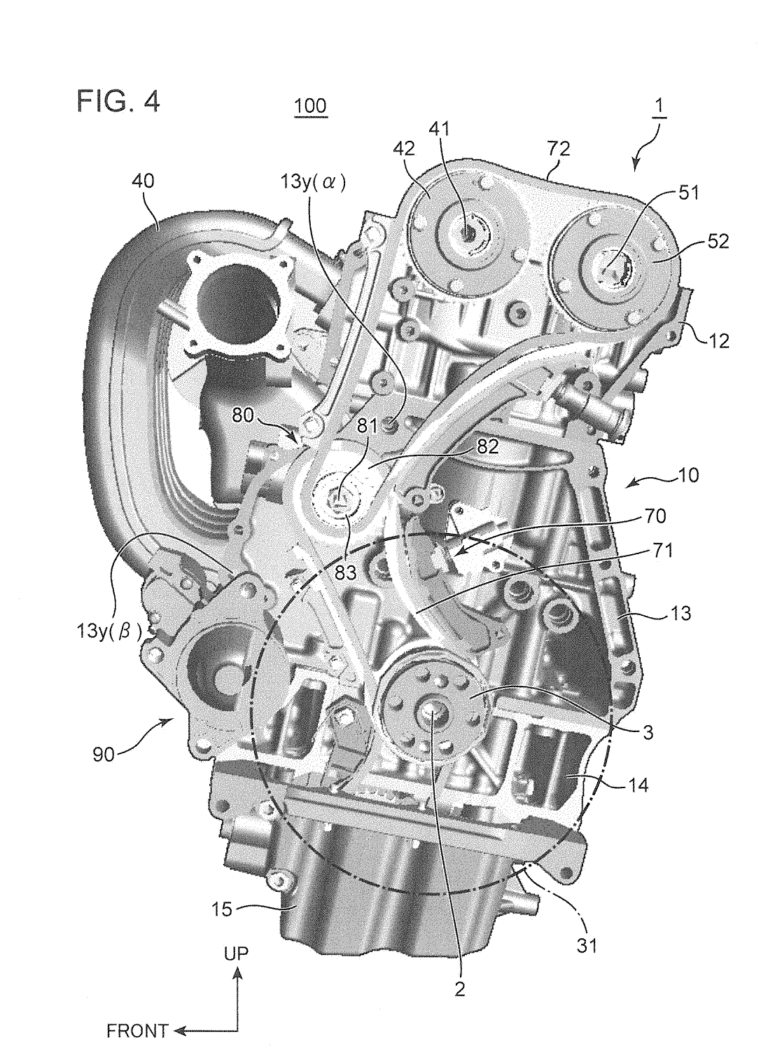

As illustrated in FIG. 1, the engine 1 includes an engine body 10, in which the first to fourth cylinders #1 to #4 are arranged in a row. As illustrated in FIG. 3 and FIG. 4, the engine body 10 includes a head cover 11, a cylinder head 12, a cylinder block 13, a lower block 14, and an oil pan 15 in this order from the upper side. These members define the external appearance of the engine body 10. A transmission 30 is engaged with an end portion of the engine body 10 on the rear side via a chain cover 20 (see FIG. 1). Output of the engine 1 is transmitted to the transmission 30 via a crankshaft 2 of the engine body 10.

Note that in the description of the embodiment, the output side of the crankshaft 2 with respect to the transmission 30 in the cylinder array direction, in other words, the output side (the transmission side) of the engine body 10 is referred to as a rear side of the engine body 10; and the side opposite to the rear side of the engine body 10 is referred to a front side of the engine body 10. Further, an end portion (in other words, an end portion on the rear side) of the engine body 10 on the rear side of the engine body 10 is referred to as a rear end portion of the engine body 10, and an end portion (in other words, an end portion on the front side) of the engine body 10 on the front side of the engine body 10 is referred to as a front end portion of the engine body 10. Note that the term “front” in the drawings indicates a front side in the vehicle front-rear direction.

In FIG. 4, a circle illustrated by a chain line indicates an outer configuration (e.g. a pitch circle) of a flywheel 31 to be described later.

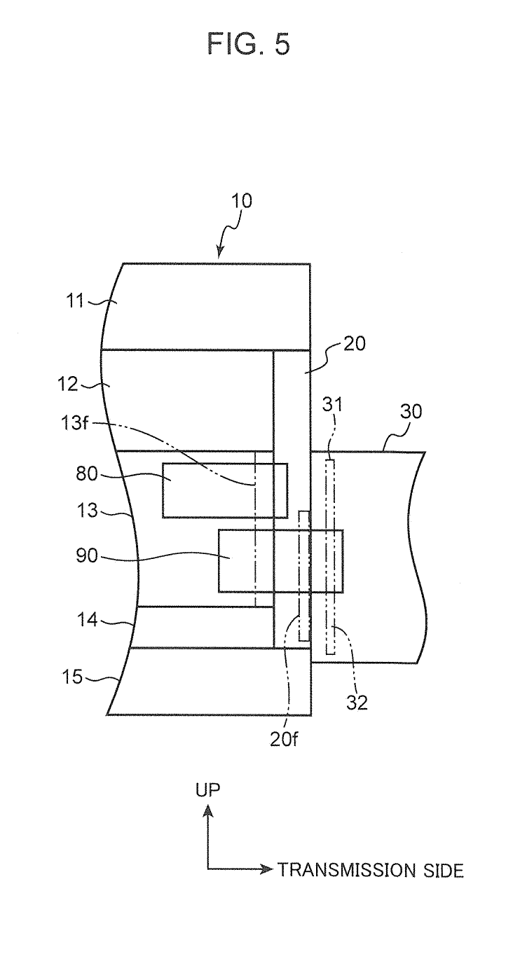

As illustrated in FIG. 5, the chain cover 20 is engaged over the cylinder head 12, the cylinder block 13, and the lower block 14; and the transmission 30 is engaged over the cylinder block 13 and the lower block 14. An intake manifold 40 is connected to a surface of the engine body 10 on the vehicle front side, and an exhaust manifold 50 is connected to a surface of the engine body 10 on the vehicle rear side (see FIG. 1). As described above, in an FF-vehicle, by disposing an intake system on the vehicle front side, and an exhaust system on the vehicle rear side, it is possible to avoid lowering of an exhaust temperature due to traveling air, and to activate an exhaust purification device (not illustrated) provided in the exhaust system in an early stage and to maintain activation of the exhaust purification device.

A front-side accessory drive device 60 configured to belt-drive a plurality of accessories (e.g. an alternator, a compressor of an air conditioner, and a water pump) is disposed on a front end portion of the engine body 10. A rear-side accessory drive device 70 configured to chain-drive a plurality of accessories (e.g. a fuel pump 80, an oil pump, and a secondary balancer shaft or a primary balancer shaft) is disposed on a rear end portion of the engine body 10. The rear-side accessory drive device 70 is accommodated in the chain cover 20.

The fuel pump 80 is disposed on a surface of the engine body 10 on the vehicle front side (on the intake side) and on a rear end portion of the engine body 10. The reason for disposing the fuel pump 80 at the aforementioned position is mainly as follows. A high-pressure fuel injection is necessary in order to enhance controllability of fuel injection as a measure for improving fuel economy of the engine 1, which is configured to directly inject fuel to a combustion chamber. Therefore, a required drive torque of the fuel pump 80 configured to feed fuel to an injector also increases. It is well-known to dispose the fuel pump 80 at ends of camshafts 41 and 51, and to drive the fuel pump 80 by using rotations of the camshafts 41 and 51. However, in a case where a variable valve timing device (VVT) is mounted on the camshafts 41 and 51, a required drive torque of the fuel pump 80 in a high pressure condition may exceed a torque to be generated by the variable valve timing device. This may make it impossible to operate the variable valve timing device. In view of the above, the fuel pump 80 is disposed at a position other than the ends of the camshafts 41 and 51 while avoiding a high temperature portion such as the exhaust manifold 50. Further, the fuel pump 80 is disposed on a side surface of the engine body 10 on the intake side, in other words, on a surface of the engine body 10 on the vehicle front side, and on a rear end portion of the engine body 10 where the rear-side accessory drive device 70 is disposed in order to chain-drive the fuel pump 80 by the crankshaft 2. Note that as a result of the aforementioned configuration, it is necessary to provide a measure for protecting the fuel pump 80 from a collision object from the vehicle front side at vehicle collision (from the front side). In this case, if a dedicated protection member is additionally provided, not only the space for the engine room 100 may be narrowed, but also the weight and the cost of the engine 1 may increase.

(1) In view of the above, in the embodiment, the fuel pump 80 configured to feed fuel to an injector, and a starter 90 configured to rotate the crankshaft 2 at an engine start time are disposed on a rear end portion of an intake manifold mounting surface of the engine body 10, and the starter 90 is disposed to project outwardly with respect to the fuel pump 80 in the engine width direction orthogonal to the cylinder array direction when the engine 1 is viewed from the cylinder array direction in order to protect the fuel pump 80 disposed on a side surface of the engine body 10 on the vehicle front side and on a rear end portion of the engine body 10 from a collision object from the vehicle front side at vehicle collision from the front side, without adding a dedicated member. In other words, the starter 90 is disposed to project forwardly of the vehicle with respect to the fuel pump 80.

Further, in the engine 1 configured such that the fuel pump 80 is disposed on a side surface of the engine body 10 on the intake side and on a rear end portion of the engine body 10, vibration of the fuel pump 80 in driving the fuel pump 80 and an increase in the engine width should be considered. In this case, if the number of engagement positions of the fuel pump 80 is increased in order to suppress vibration, the number of parts and a time required for assembling may increase.

(2) In view of the above, in the embodiment, a transmission engagement rib 13z to be engaged with the transmission 30, and a fuel pump mounting portion 13f on which the fuel pump 80 is mounted from the front side are provided on a rear end portion of the engine body 10; and a part or the entirety of the fuel pump mounting portion 13f is located within an area of a transmission engagement portion 13g when the engine 1 is viewed from the cylinder array direction in order to suppress vibration of the fuel pump 80 in driving the fuel pump 80 and an increase in the engine width, which is disposed on a side surface of the engine body 10 on the intake side and on the rear end portion of the engine body 10, without increasing the number of engagement positions of the fuel pump 80.

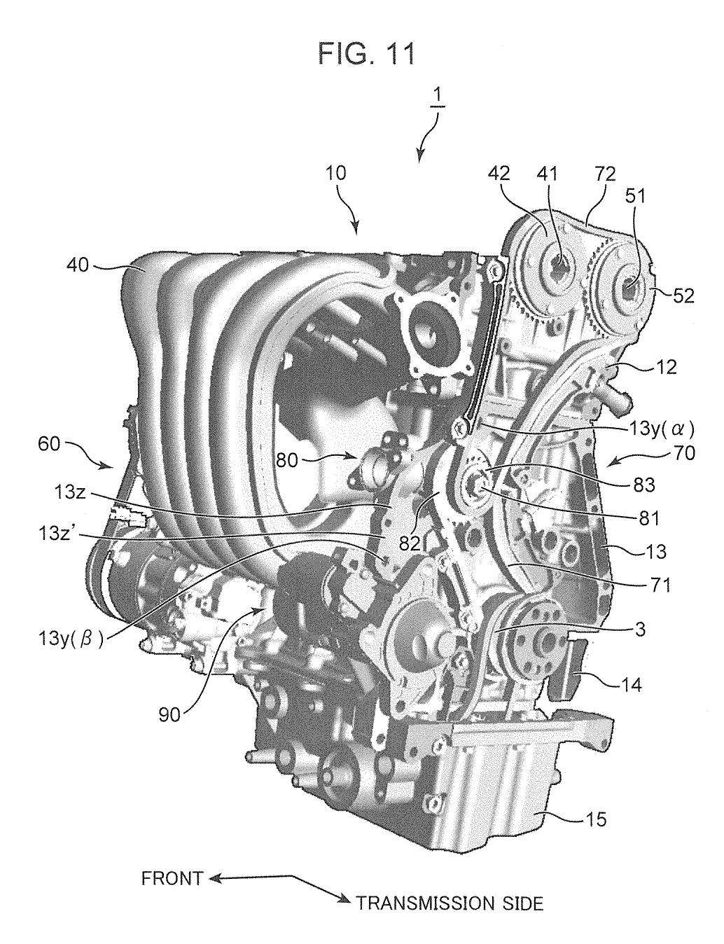

Specifically, as illustrated in FIG. 2, FIG. 4, and FIG. 11, the fuel pump 80 is disposed on the upper front side of the crankshaft 2 on a rear end portion of the engine body 10 when engine body 10 is viewed from a direction of the crankshaft, and the starter 90 is disposed on the lower side of the fuel pump 80. The fuel pump 80 is located at a relatively upper portion of the cylinder block 13. Therefore, the fuel pump 80 is disposed relatively proximal to a cylinder bore (not illustrated) in the vehicle front-rear direction. On the other hand, the position of the starter 90 is a position corresponding to a peripheral edge portion of the flywheel 31 (see FIG. 4 and FIG. 5) on the vehicle front side, which is concentrically mounted on the crankshaft 2. Therefore, the starter 90 is disposed relatively away from the cylinder bore in the vehicle front-rear direction. Consequently, the starter 90 is disposed to project forwardly of the vehicle with respect to the fuel pump 80.

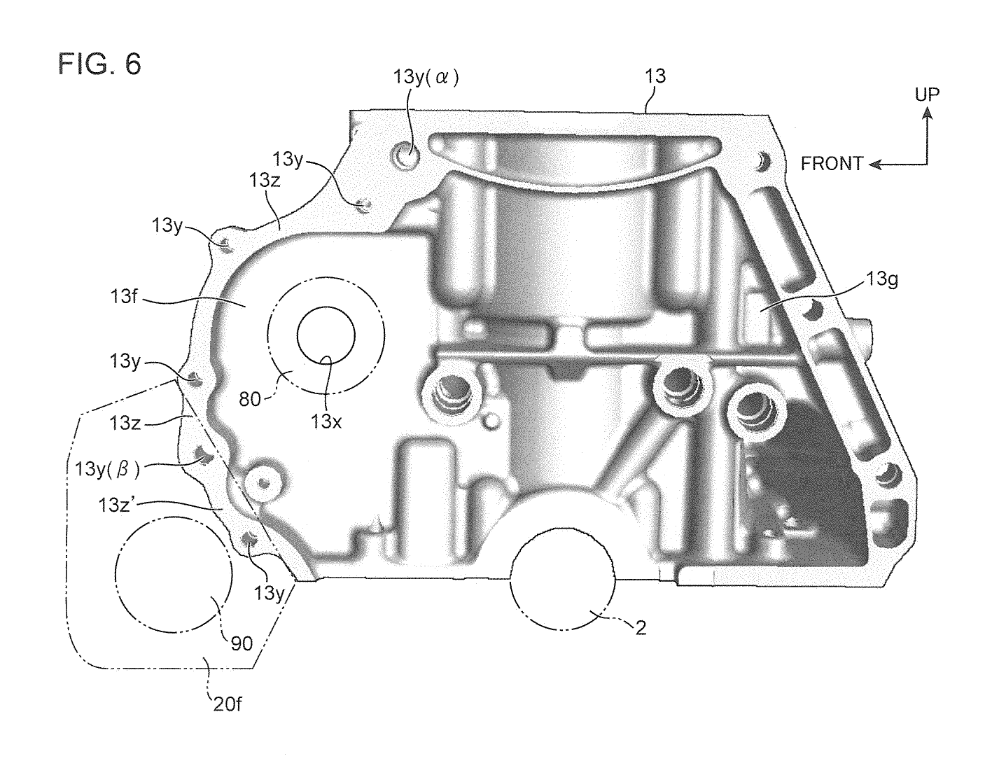

The fuel pump 80 is mounted on the cylinder block 13. Specifically, as illustrated in FIG. 5 and FIG. 6, the flange-shaped fuel pump mounting portion 13f bulging on the vehicle front side is formed on a rear end portion of the cylinder block 13, and the fuel pump 80 is mounted on the fuel pump mounting portion 13f from the vehicle right side (the side opposite to the transmission) (see FIG. 3). An engagement bolt (not illustrated) for use in mounting the fuel pump 80 passes through an insertion hole formed in a mounting seat of the fuel pump 80 from the vehicle right side (the side opposite to the transmission), and engages in the fuel pump mounting portion 13f.

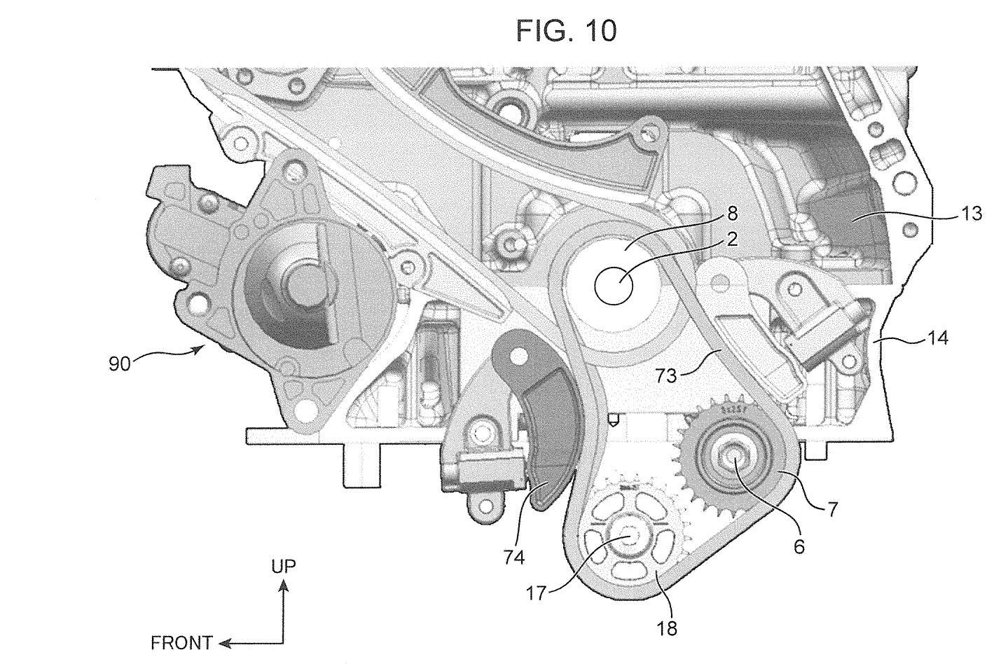

The fuel pump 80 is chain-driven by the crankshaft 2 with use of the rear-side accessory drive device 70. Specifically, a drive shaft 81 (see FIG. 4) of the fuel pump 80 passes through an opening 13x (see FIG. 6) formed in the fuel pump mounting portion 13f, and projects into an inner space of the chain cover 20. Further, a first chain 71 is wound around a first sprocket 82 of a relatively large diameter and mounted on a projection portion of the drive shaft 81, and a crankshaft sprocket 3 mounted on an end of the crankshaft 2 on the output side and projecting into the inner space of the chain cover 20. According to this configuration, the fuel pump 80 is chain-driven by the crankshaft 2 via the first chain 71. Note that in FIG. 4, illustration of teeth of sprockets and unit structures of chains is omitted (illustration is also omitted in FIG. 10).

The starter 90 is mounted on the chain cover 20. Specifically, as illustrated in FIG. 3 and FIG. 5, a flange-shaped starter mounting portion 20f bulging on the vehicle front side is formed on the chain cover 20 (see FIG. 6). The starter 90 is mounted on the starter mounting portion 20f from the vehicle right side (the side opposite to the transmission). An engagement bolt (not illustrated) for use in mounting the starter 90 passes through an insertion hole formed in a mounting seat of the starter 90 from the vehicle right side (the side opposite to the transmission) or from the vehicle left side (the transmission side), and engages in the starter mounting portion 20f.

Note that in the embodiment, the starter mounting portion 20f is formed on the chain cover 20. Alternatively, the starter mounting portion 20f may be a plate-shaped member (not illustrated), which is configured to interpose between a rear end portion of the engine body 10 and the chain cover 20, or between the chain cover 20 and the transmission 30.

Although not illustrated in detail, a pinion gear of the starter 90 passes through an opening formed in the chain cover 20, projects into an inner space of the transmission 30, and engages with a ring gear 32 formed on a peripheral edge portion of the flywheel 31, which is concentrically mounted on the crankshaft 2.

Note that as illustrated in FIG. 4, an upper portion of the engine body 10 is slanted at a predetermined angle rearwardly of the vehicle. This is mainly for the purpose of securing a layout space for an intake system including the intake manifold 40, which is disposed on the vehicle front side.

Note that a positional relationship between the starter 90 and the fuel pump 80 may be such that at least the starter 90 projects forwardly of the vehicle with respect to the fuel pump 80 when the engine body 10 is slanted.

Further, as illustrated in FIG. 4, the intake camshaft 41 and the exhaust camshaft 51 disposed on an upper portion of the cylinder head 12 are chain-driven by the crankshaft 2 with use of the rear-side accessory drive device 70. Specifically, a second sprocket 83 whose diameter is smaller than the diameter of the first sprocket 82 is mounted on a projection portion of the drive shaft 81 of the fuel pump 80 projecting into an inner space of the chain cover 20. Further, a second chain 72 is wound around the second sprocket 83, an intake camshaft sprocket 42 mounted on a projection portion of the intake camshaft 41 projecting into an inner space of the chain cover 20, and an exhaust camshaft sprocket 52 mounted on a projection portion of the exhaust camshaft 51 projecting into the inner space of the chain cover 20. According to this configuration, the intake camshaft 41 and the exhaust camshaft 51 are chain-driven by the crankshaft 2 via the first chain 71 and the second chain 72, which are wound around the fuel pump drive shaft 81.

(3) In the embodiment, a rear end portion of the engine body 10 includes the transmission engagement rib 13z to be engaged with the transmission 30. The fuel pump 80 is disposed on the upper side with respect to the starter 90 in the up-down direction of the engine. At least a part (a vehicle front portion 13z′) of the transmission engagement rib 13z lies between the fuel pump 80 and the starter 90 (see FIG. 11).

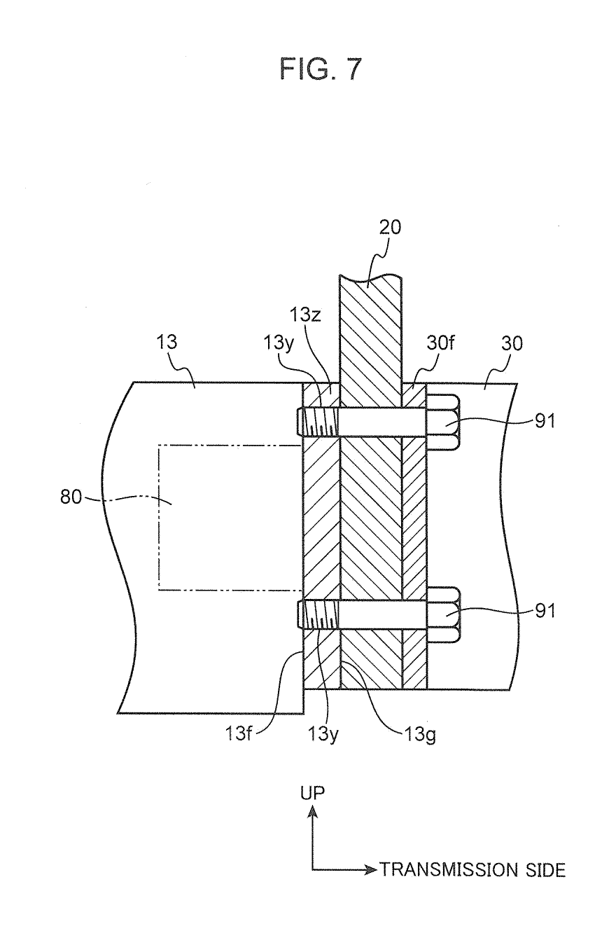

Specifically, as illustrated in FIG. 6, the transmission engagement portion 13g to be engaged with the transmission 30 is formed on a rear end portion of the cylinder block 13, and the transmission engagement rib 13z is formed on an outer peripheral portion of the transmission engagement portion 13g. The transmission engagement portion 13g has an area larger than the area of the fuel pump mounting portion 13f. The entirety of the fuel pump mounting portion 13f is located within the area of the transmission engagement portion 13g when the engine 1 is viewed form a direction of the crankshaft. The transmission 30 is mounted on the transmission engagement portion 13g from the vehicle left side (the transmission side) (see FIG. 1 and FIG. 7). Engagement bolts (not illustrated) for use in mounting the transmission 30 pass through insertion holes formed in a mounting seat of the transmission 30 from the vehicle left side (the transmission side), and engage with boss portions 13y formed on the transmission engagement rib 13z.

In addition to the above, the fuel pump 80 mounted on the fuel pump mounting portion 13f of the cylinder block 13 from the vehicle right side (the side opposite to the transmission) is located on the upper rear side of the vehicle front portion 13z′ of the transmission engagement rib 13z (a lower portion of a lateral edge portion of the transmission in proximity to the starter 90 in FIG. 6), and the starter 90 mounted on the starter mounting portion 20f of the chain cover 20 from the vehicle right side (the side opposite to the transmission) is located on the lower front side of the vehicle front portion 13z′. In other words, the fuel pump 80 and the starter 90 are disposed in the up-down direction with respect to the vehicle front portion 13z′.

(4) In the embodiment, the chain cover 20 configured to cover the chains 71 and 72, and the sprockets 3, 42, 52, 82, and 83 disposed on a rear end surface of the engine body 10 (in other words, the rear-side accessory drive device 70) is mounted between the transmission engagement rib 13z and the transmission 30. Further, the transmission engagement rib 13z, the chain cover 20, and the transmission 30 are engaged with each other.

Specifically, as illustrated in FIG. 7, a flange 30f is formed on an end portion of the transmission 30 on the engagement side (in the embodiment, on a right end portion of the transmission 30). Engagement bolts 91 pass through the transmission-side flange 30f and the chain cover 20 from the vehicle left side (the transmission side) (more specifically, insertion holes formed in a mounting seat of the chain cover 20), and engage with the boss portions 13y of the transmission engagement rib 13z in a state that the chain cover 20 is interposed between the transmission-side flange 30f, and the transmission engagement rib 13z on a rear end portion of the cylinder block 13.

(5) In the embodiment, the transmission engagement portion 13g includes the transmission engagement rib 13z on an outer peripheral portion thereof. The plurality of boss portions 13y through which engagement bolts are inserted are formed on the transmission engagement rib 13z. The fuel pump mounting portion 13f is located between predetermined two of the plurality of boss portions 13y.

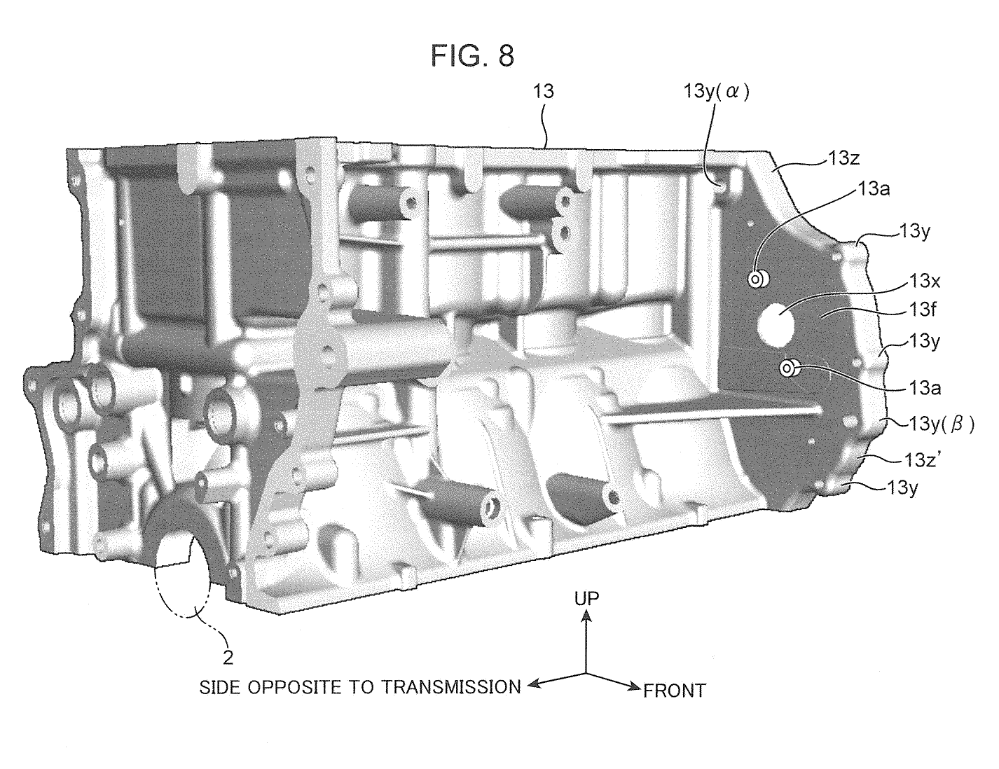

Specifically, as illustrated by reference numerals 13y(α) and 13y(β) in FIG. 6 and FIG. 8, the fuel pump mounting portion 13f, the opening 13x through which the fuel pump drive shaft 81 is inserted, and the upper rear boss portion 13y(α) and the lower front boss portion 13y(β) facing each other with respect to the fuel pump 80 are provided on the transmission engagement rib 13z on an outer peripheral portion of the transmission engagement portion 13g (see FIG. 4 and FIG. 11).

In this example, in FIG. 7, the two boss portions 13y engageable with the engagement bolts 91 are the upper boss portion 13y(α) on the upper side and the lower boss portion 13y(β) on the lower side.

Note that in FIG. 8, the reference numerals 13a denote fuel pump mounting boss portions. The paired fuel pump mounting boss portions 13a are formed on the upper side and the lower side with respect to the opening 13x through which the fuel pump drive shaft 81 is inserted, and project on the vehicle right side (toward the side opposite to the transmission) from the fuel pump mounting portion 13f. Engagement bolts (not illustrated) for use in mounting the fuel pump 80 pass through insertion holes formed in a mounting seat of the fuel pump 80 from the vehicle right side (the side opposite to the transmission), and engage with the fuel pump mounting boss portions 13a.

(6) In the embodiment, along a rear end surface of the engine body 10, there are provided the crankshaft sprocket 3 mounted on an end of the crankshaft 2, the first sprocket 82 and the second sprocket 83 mounted side by side on the drive shaft 81 of the fuel pump 80, the intake camshaft sprocket 42 mounted on the intake camshaft 41, the first chain 71 wound around the crankshaft sprocket 3 and the first sprocket 82, and the second chain 72 wound around the second sprocket 83 and the intake camshaft sprocket 42.

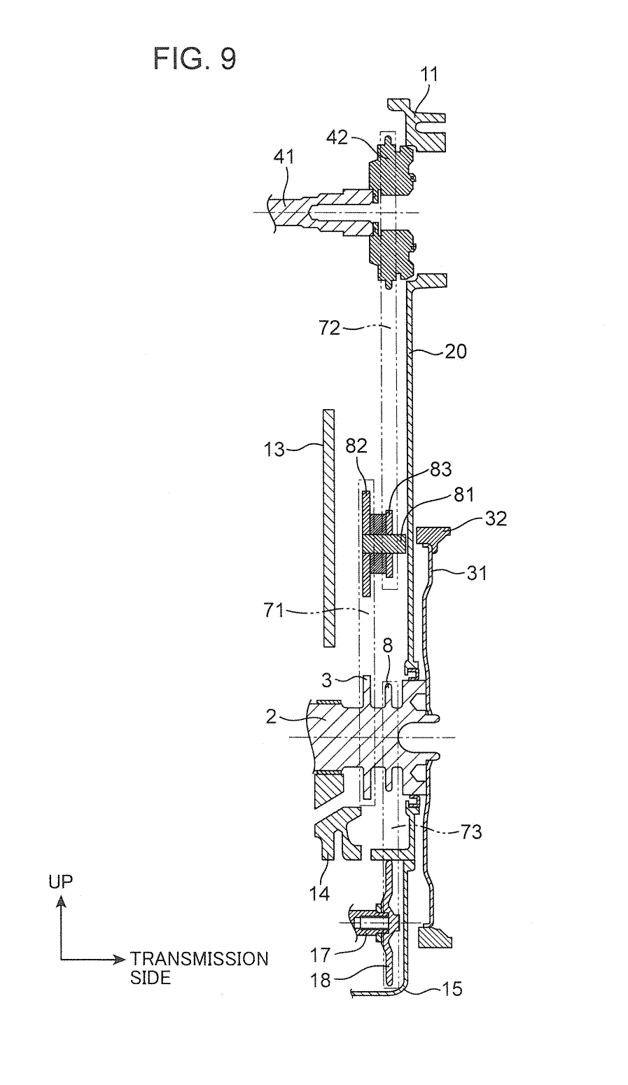

Specifically, as illustrated in FIG. 4, FIG. 9, and FIG. 10, the second chain 72 is wound around the intake camshaft sprocket 42 of the intake camshaft 41 and the exhaust camshaft sprocket 52 of the exhaust camshaft 51, which are located at a relatively upper position of the engine body 10; and the second sprocket 83 of the fuel pump drive shaft 81 located at an intermediate portion of the engine body 10 in the up-down direction of the engine body 10. Further, the first chain 71 is wound around the first sprocket 82 of the fuel pump drive shaft 81, and the crankshaft sprocket 3 of the crankshaft 2. Further, a third chain 73 is wound around the drive sprocket 8 of the crankshaft 2, a balancer shaft sprocket 7 of a balancer drive shaft 6 located at a relatively lower position of the engine body 10, and an oil pump sprocket 18 of an oil pump drive shaft 17 within the oil pan 15. According to this configuration, the fuel pump 80 is chain-driven by the crankshaft 2 via the first chain 71, and the intake camshaft 41 and the exhaust camshaft 51 are chain-driven by the crankshaft 2 via the first chain 71 and the second chain 72. Further, although not illustrated, an oil pump, and a secondary balancer shaft or a primary balancer shaft within the oil pan 15 are chain-driven by the crankshaft 2 via the third chain 73.

(7) In the embodiment, the upper boss portion 13y(α) out of the predetermined two boss portions 13y(α) and 13y(β) is located within an area surrounded by the second chain 72 (see FIG. 11).

Specifically, as illustrated in FIG. 4, the fuel pump mounting portion 13f, the opening 13x through which the fuel pump drive shaft 81 is inserted, and the upper rear boss portion 13y(α) out of the upper rear boss portion 13y(α) and the lower front boss portion 13y(β) facing each other with respect to the fuel pump 80 are located within an area surrounded by the second chain 72. The upper boss portion 13y(α) is located on a relatively rear side. Therefore, a front portion of the second chain 72, out of a pair of front and rear portions of the second chain 72 extending upwardly from the second sprocket 83 mounted on the fuel pump drive shaft 81 is also located on a relatively rear side. This means that the front portion of the second chain 72, out of the paired front and rear portions of the second chain 72 extending upwardly from the second sprocket 83, has a larger angle with respect to the intake camshaft sprocket 42.

(8) In the embodiment, the fuel pump 80 and the starter 90 are mounted on an intake manifold mounting surface of the engine 1. A part of the intake manifold 40 projects outwardly with respect to the fuel pump 80 in the engine width direction when the engine 1 is viewed from a direction of the crankshaft. The intake manifold 40 is disposed on a side surface of the engine body 10 on the vehicle front side in such a manner that a part of the intake manifold overlaps the fuel pump 80 when the engine 1 is viewed from the intake manifold mounting surface.

Specifically, as illustrated in FIG. 3, the fuel pump 80 extends in the cylinder array direction, and a rear end portion (an end portion on the transmission side) of the engine body 10 projects into an inner space of the chain cover 20. Further, a front end portion of the engine body 10 projects to a position below the arch of a branch pipe of the intake manifold 40 (see FIG. 2 and FIG. 4).

Next, advantageous effects of the embodiment are described.

(1) In the embodiment, in an accessory mounting structure for the engine 1 including the engine body 10 in which the plurality of cylinders #1 to #4 are arranged in a row, and the transmission 30 disposed on an end of the engine body 10 in the cylinder array direction and to which output of the engine 1 is transmitted via the crankshaft 2 of the engine body 10, when an output side of the crankshaft 2 with respect to the transmission 30 in the cylinder array direction is defined as a rear side, and a side of the crankshaft 2 opposite to the output side is defined as a front side, the fuel pump 80 configured to feed fuel to an injector, and the starter 90 configured to rotate the crankshaft 2 at an engine start time are disposed on a rear end portion of an intake manifold mounting surface of the engine body 10, and the starter 90 projects outwardly with respect to the fuel pump 80 in the engine width direction orthogonal to the cylinder array direction when the engine 1 is viewed from the cylinder array direction. According to this configuration, the starter 90 comes into contact with a collision object from the vehicle front side prior to the fuel pump 80 at vehicle collision from the front side. Therefore, it is possible to protect the fuel pump 80 without adding a dedicated member.

(2) In the embodiment, the rear end portion of the engine body 10 includes the transmission engagement rib 13z to be engaged with the transmission 30. The fuel pump 80 is disposed on the upper side with respect to the starter 90 in the up-down direction of the engine. A least a part (the vehicle front portion 13z′) of the transmission engagement rib 13z lies between the fuel pump 80 and the starter 90. According to this configuration, even in a case where a large load is exerted on the starter 90 due to a contact with a collision object from the vehicle front side, and the starter 90 is displaced on the upper side, the aforementioned displacement of the starter 90 is restricted by the vehicle front portion 13z′ of the transmission engagement rib 13z. Therefore, the aforementioned configuration is further advantageous in securely protecting the fuel pump 80.

(3) In the embodiment, the rear end portion of the engine body 10 includes the transmission engagement rib 13z to be engaged with the transmission 30, and the fuel pump mounting portion 13f to which the fuel pump 80 is mounted from the front side. A part or an entirety of the fuel pump mounting portion 13f is located within an area of the transmission engagement portion 13g when the engine 1 is viewed from the cylinder array direction. According to this configuration, a part or the entirety of the fuel pump 80 is mounted within an area of the transmission engagement portion 13g, whose rigidity is increased by engagement with the transmission 30 on the rear end portion of the engine body 10. This makes it possible to suppress vibration of the fuel pump 80 in driving the fuel pump 80 and an increase in the engine width, without increasing the number of engagement positions of the fuel pump 80.

(4) In the embodiment, the chain cover 20 configured to cover the chains 71 and 72, and the sprockets 3, 42, 52, 82, and 83 disposed on a rear end surface of the engine body 10 is mounted between the transmission engagement rib 13z and the transmission 30. Further, the transmission engagement rib 13z, the chain cover 20, and the transmission 30 are engaged with each other. According to this configuration, it is possible to increase the rigidity of the transmission engagement rib 13z. Therefore, the aforementioned configuration is advantageous in securely restricting the aforementioned displacement of the starter 90.

(5) In the embodiment, the transmission engagement portion 13g includes the transmission engagement rib 13z on an outer peripheral portion thereof. The plurality of boss portions 13y through which engagement bolts are inserted are formed on the transmission engagement rib 13z. The fuel pump mounting portion 13f is located between predetermined two boss portions 13y(α) and 13y(β) of the plurality of boss portions 13y. According to this configuration, the fuel pump 80 is mounted between the two boss portions 13y(α) and 13y(β) by which the rigidity of the transmission engagement rib 13z is increased by insertion of engagement bolts. Therefore, the aforementioned configuration is further advantageous in securely suppressing vibration of the fuel pump 80 in driving the fuel pump 80.

(6) In the embodiment, along a rear end surface of the engine body 10, there are disposed the crankshaft sprocket 3 mounted on an end of the crankshaft 2, the first sprocket 82 and the second sprocket 83 mounted side by side on the drive shaft 81 of the fuel pump 80, the intake camshaft sprocket 42 mounted on the intake camshaft 41, the first chain 71 wound around the crankshaft sprocket 3 and the first sprocket 82, and the second chain 72 wound around the second sprocket 83 and the intake camshaft sprocket 42. According to this configuration, the fuel pump 80 is chain-driven by the crankshaft 2 via the first chain 71, and the intake camshaft 41 is chain-driven by the crankshaft 2 via the first chain 71 and the second chain 72. In this case, at least a part of the fuel pump 80 is mounted within an area of the transmission engagement portion 13g on a rear end portion of the engine body 10. Therefore, as compared with a case where the entirety of the fuel pump 80 is mounted in an area outside the area of the transmission engagement portion 13g (in other words, a case where the fuel pump 80 is mounted to project on the intake side of the engine body 10), it is possible to secure a sufficient angle of engagement of the second chain 72 with respect to the intake camshaft sprocket 42 (in other words, it is possible to increase the angle). This makes it possible to drive both of the intake camshaft 41 and the exhaust camshaft 51 by the second chain 72, which does not require a gear between the camshafts. Therefore, it is possible to eliminate gear noise. Further, it is possible to increase the pitch of the second chain 72. This makes it possible to extend the life of the second chain 72.

(7) In the embodiment, the upper boss portion 13y(α) out of the predetermined two boss portions 13y(α) and 13y(β) is located within an area surrounded by the second chain 72. According to this configuration, it is possible to increase the angle of engagement of the second chain 72 with respect to the intake camshaft sprocket 42. Therefore, the aforementioned configuration is advantageous in eliminating the gear noise and in strengthening the function of extending the life of a chain.

(8) In the embodiment, the fuel pump 80 and the starter 90 are mounted on the intake manifold mounting surface of the engine 1. A part of the intake manifold 40 projects outwardly with respect to the fuel pump 80 in the engine width direction when the engine 1 is viewed from a direction of the crankshaft. The intake manifold 40 is disposed on a side surface of the engine body 10 on the vehicle front side in such a manner that a part of the intake manifold 40 overlaps the fuel pump 80 when the engine 1 is viewed from the intake manifold mounting surface. According to this configuration, the intake manifold 40 also serves as a protection member of the fuel pump 80. Therefore, the aforementioned configuration is advantageous in protecting the fuel pump 80 from a collision object from the vehicle front side by the intake manifold 40.

In the foregoing, the present invention is described in detail by an embodiment. The present invention, however, is not limited to the aforementioned embodiment. For instance, in the embodiment, the entirety of the fuel pump mounting portion 13f is located within an area of the transmission engagement portion 13g when the engine 1 is viewed from a direction of the crankshaft. Alternatively, a part of the fuel pump mounting portion 13f may be located within an area of the transmission engagement portion 13g when the engine 1 is viewed from a direction of the crankshaft.

Further, the layout of the engine or the type of the vehicle is not specifically limited. For instance, in the embodiment, there is used an FF-vehicle, in which an engine is transversely mounted in such a manner that an intake system is disposed on the vehicle front side, and an exhaust system is disposed on the vehicle rear side. Alternatively, the vehicle may an FF-vehicle, in which an engine is longitudinally mounted. Further alternatively, the vehicle may be an FF-vehicle, in which an engine is transversely mounted, and an intake system is disposed on the vehicle rear side and an exhaust system is disposed on the vehicle front side.

1. An accessory mounting structure for an engine including an engine body in which a plurality of cylinders are arranged in a row, and a transmission disposed on an end of the engine body in the cylinder array direction and to which output of the engine is transmitted via a crankshaft of the engine body, the accessory mounting structure including:
when an output side of the crankshaft with respect to the transmission in the cylinder array direction is defined as a rear side, and a side of the crankshaft opposite to the output side is defined as a front side,
a fuel pump configured to feed fuel to an injector, and a starter configured to rotate the crankshaft at an engine start time are disposed on a rear end portion of an intake manifold mounting surface of the engine body, and
the starter projects outwardly with respect to the fuel pump in an engine width direction orthogonal to the cylinder array direction when the engine is viewed from the cylinder array direction.

2. The accessory mounting structure for an engine according to claim 1, wherein
the rear end portion of the engine body includes a transmission engagement rib to be engaged with the transmission,
the fuel pump is disposed on an upper side with respect to the starter in an up-down direction of the engine, and
at least a part of the transmission engagement rib lies between the fuel pump and the starter.

3. The accessory mounting structure for an engine according to claim 1, wherein
the rear end portion of the engine body includes a transmission engagement rib to be engaged with the transmission, and a fuel pump mounting portion to which the fuel pump is mounted from the front side, and
a part or an entirety of the fuel pump mounting portion is located within an area of the transmission engagement portion when the engine is viewed from the cylinder array direction.

4. The accessory mounting structure for an engine according to claim 1, wherein
a chain cover configured to cover a chain and a sprocket disposed on a rear end surface of the engine body is mounted between the transmission engagement rib and the transmission, and
the transmission engagement rib, the chain cover, and the transmission are engaged with each other.

5. The accessory mounting structure for an engine according to claim 3, wherein
the transmission engagement portion includes the transmission engagement rib on an outer peripheral portion thereof,
a plurality of boss portions through which engagement bolts are inserted are formed on the transmission engagement rib, and
the fuel pump mounting portion is located between predetermined two of the plurality of boss portions.

6. The accessory mounting structure for an engine according to claim 5, wherein
along a rear end surface of the engine body, there are disposed a crankshaft sprocket mounted on an end of the crankshaft,
a first sprocket and a second sprocket mounted side by side on a drive shaft of the fuel pump,
an intake camshaft sprocket mounted on an intake camshaft,
a first chain wound around the crankshaft sprocket and the first sprocket, and
a second chain wound around the second sprocket and the intake camshaft sprocket.

7. The accessory mounting structure for an engine according to claim 6, wherein
an upper boss portion out of the predetermined two boss portions is located within an area surrounded by the second chain.

8. The accessory mounting structure for an engine according to claim 1, wherein
the fuel pump and the starter are mounted on the intake manifold mounting surface of the engine,
a part of an intake manifold projects outwardly with respect to the fuel pump in an engine width direction when the engine is viewed from a direction of the crankshaft, and
the intake manifold is disposed on a side surface of the engine body on a vehicle front side in such a manner that a part of the intake manifold overlaps the fuel pump when the engine is viewed from the intake manifold mounting surface.
